(19) United States
(12) Patent Application Publication
(10) Pub. No.: US 2025/0206972 A1
(43) Pub. Date: Jun. 26, 2025

(54) AQUEOUS INK, INK CARTRIDGE AND INK JET RECORDING METHOD

(71) Applicant: CANON KABUSHIKI KAISHA, Tokyo (JP)

(72) Inventors: MUTSUKI KUSADA, Chiba (JP); KENICHI SHIIBA, Saitama (JP); TOMOAKI ISHII, Saitama (JP)

(21) Appl. No.: 18/989,685

(22) Filed: Dec. 20, 2024

(30) Foreign Application Priority Data
Dec. 21, 2023 (JP) 2023-215835
Nov. 29, 2024 (JP) 2024-208489

(51) Int. Cl. C09D 11/322; C09B 29/33; C09B 48/00; C09B 67/22; C09D 17/00

(52) U.S. Cl. CPC C09D 11/322; C09B 48/00; C09B 29/33; C09B 67/0033; C09D 17/003

(57) ABSTRACT

Provided is an aqueous ink for ink jet, which is excellent in sticking recoverability and capable of suppressing bronzing. The aqueous ink for ink jet includes a pigment. The pigment includes a first pigment that is a quinacridone pigment and a second pigment that is a monoazo pigment free of a condensed ring in a molecule thereof. A hue angle of a diluted solution obtained by diluting the ink with water so that an absorbance at a maximum absorption wavelength in a wavelength range of from 380 nm to 780 nm is 1 is 3300 or more to 3450 or less.

### BACKGROUND OF THE INVENTION

### Field of the Invention

The present invention relates to an aqueous ink, an ink cartridge and an ink jet recording method.

### Description of the Related Art

In recent years, an ink jet recording method has enabled the recording of an image having high definition and excellent color developability as achieved by silver halide photography or offset recording. A dye or a pigment is available as a coloring material to be used in an ink. Of those, a pigment is widely used as a coloring material from the viewpoint of being capable of recording an image excellent in fastness property, such as resistance to a gas, resistance to light or resistance to water.

In an ink jet recording method, an image is generally recorded with inks of four colors: black in addition to the three primary colors of cyan, magenta and yellow. A quinacridone pigment excellent in fastness property has hitherto been widely used as a magenta-based pigment (hereinafter sometimes referred to as “magenta pigment”) to be used in a magenta ink. However, a magenta ink using a quinacridone pigment has a problem in that sticking recoverability is liable to be decreased, and hence there has been a demand for improvement of performance. The sticking recoverability refers to the performance that allows an ink to be recovered to a state in which the ink is properly ejected even after the ink is filled into a recording head and left for a long period of time by activating a recovery mechanism to dissolve the sticking of the ink in an ink flow path or an ejection orifice.

In Japanese Patent Application Laid-Open No. 2022-022134, various proposals have hitherto been made in order to solve such problem. For example, there has been proposed an ink capable of suppressing the sticking of a quinacridone pigment to keep a satisfactory ejection property through use of an azo pigment together with the quinacridone pigment. In addition, in each of Japanese Patent Application Laid-Open No. 2003-313480 and Japanese Patent Application Laid-Open No. 2012-188502, there has been proposed an ink containing a magenta-based pigment and a yellow pigment.

### SUMMARY OF THE INVENTION

The inventors of the present invention have investigated an ink containing an azo pigment together with a quinacridone pigment among various inks proposed in Japanese Patent Application Laid-Open No. 2022-022134, Japanese Patent Application Laid-Open No. 2003-313480 and Japanese Patent Application Laid-Open No. 2012-188502. As a result, it has been found that, although the sticking recoverability is satisfactory, so-called bronzing, in which light of a color different from the original color of the magenta pigment is observed depending on the angle at which an image is observed, occurs significantly.

Thus, an object of the present invention is to provide an aqueous ink for ink jet, which is excellent in sticking recoverability and capable of suppressing bronzing. Another object of the present invention is to provide an ink cartridge and an ink jet recording method each using the aqueous ink.

That is, according to the present invention, there is provided an aqueous ink for ink jet including a pigment, wherein the pigment includes a first pigment that is a quinacridone pigment and a second pigment that is a monoazo pigment free of a condensed ring in a molecule thereof, and wherein a hue angle of a diluted solution obtained by diluting the aqueous ink with water so that an absorbance at a maximum absorption wavelength in a wavelength range of from 380 nm to 780 nm is 1 is 330° or more to 345° or less.

Further features of the present invention will become apparent from the following description of exemplary embodiments with reference to the attached drawings.

### BRIEF DESCRIPTION OF THE DRAWINGS

FIG. 1 is a sectional view for schematically illustrating an ink cartridge according to one embodiment of the present invention.

FIG. 2A and FIG. 2B are views for schematically illustrating an example of an ink jet recording apparatus to be used in an ink jet recording method of the present invention, in which FIG. 2A is a perspective view of the main portion of the ink jet recording apparatus and FIG. 2B is a perspective view of a head cartridge.

### DESCRIPTION OF THE EMBODIMENTS

The present invention is described in more detail below by way of exemplary embodiments. In the description herein, the term “C.I.” means an abbreviation for “color index”. Physical property values are values at normal temperature (25° C.) unless otherwise stated.

First, a method of calculating the hue angle of an ink is described. In the present invention, the range of a hue angle is used in order to specify that the ink has a hue as a magenta ink. In the present invention, for convenience, the hue angle of the ink is measured through use of a diluted solution obtained by diluting the ink with water (suitably ion-exchanged water or deionized water) in order to set the concentration to be suitable for measurement with a general spectrophotometer. The hue angle of the ink and the diluted solution thereof may be measured and calculated in accordance with the following procedure. First, the ink is diluted with water so that the absorbance at the maximum absorption wavelength in a wavelength range of from 380 nm to 780 nm is 1 to provide a diluted solution. Then, the resultant diluted solution is loaded into a quartz glass cell having an optical path length of 10 mm, and its absorption spectrum in a wavelength region of from 200 nm to 800 nm is measured with a spectrophotometer. For example, a product available under the product name “Spectrophotometer U-3900H” from Hitachi High-Tech Corporation may be used as the spectrophotometer. Needless to say, the spectrophotometer is not limited thereto as long as similar measurement can be performed. L*, a* and b* in a CIE L*a*b* color system are calculated from the measured absorption spectrum of the diluted solution, and then a hue angle “h” in an L*C*h color system may be calculated.

The inventors of the present invention have investigated an image recorded with an ink containing a quinacridone pigment and an azo pigment. As a result, it was found that significant bronzing occurred in the image. When the recorded image was further analyzed, the following was found. The hue of diffused light of the magenta pigment was located in the fourth quadrant (the value of a* is positive, and the value of b* is negative) in an a*b* plane of the CIE L*a*b* color system. Meanwhile, the hue of specularly reflected light causing bronzing was located in the first quadrant (the value of a* is positive, and the value of b* is positive) in the a*b* plane. In general, a difference in hue between different quadrants across an a* axis and a b* axis in the a*b* plane is easily visually recognized. In the image recorded with the above-mentioned ink, the b* of the specularly reflected light, which causes bronzing, is located on the positive side across the b* axis with respect to the b* of the diffused light. Thus, it is conceived that the yellow tinge of the specularly reflected light was strongly visually recognized, and bronzing became more noticeable. In order to suppress such bronzing, it is required to reduce the value of the b* of the specularly reflected light.

The inventors have investigated a combination of pigments, which may reduce the value of the b* of the specularly reflected light from the image while improving the sticking recoverability. As a result, it has been found that the combination of a quinacridone pigment (first pigment) and a monoazo pigment (second pigment) free of a condensed ring in a molecule thereof is effective. Thus, the inventors have reached the present invention.

The inventors have analyzed in detail an image recorded with the above-mentioned ink containing the first pigment and the second pigment. As a result, it has been found that the specularly reflected light from the image recorded with the above-mentioned ink has a higher reflectance of blue light as compared to the specularly reflected light from the image in which bronzing occurred significantly. It is conceived that blue light, which is the complementary color of yellow, was subjected to additive color mixing, and the tinge of the specularly reflected light was brought close to white, resulting in reduction in value of the b* and suppression of bronzing.

It is conceived that the first pigment and the second pigment specifically interact with each other. The quinacridone pigment that is the first pigment has a carbonyl group (>C═O) and an imino group (>NH) that are polarized groups, and also has a crystal plane in which these polarized groups are present in a particularly large amount. In addition, the monoazo pigment free of a condensed ring in a molecule thereof, which is the second pigment, also has an electron-donating group (donor), which is electrically negative, and an electron-accepting group (acceptor), which is electrically positive, bonded to each other via an azo group, and the pigment is polarized at both terminals of an azo bond. It is conceived that, in the ink, the two kinds of pigments are present in such a state that the pigments are combined with each other through the specific interaction in which the polarized monoazo pigment is attracted to the carbonyl group or imino group of the quinacridone pigment.

Meanwhile, it is conceived that a disazo pigment and a condensed azo pigment each having a plurality of azo bonds are not subjected to the specific interaction with the quinacridone pigment. The disazo pigment and the condensed azo pigment generally have highly symmetric structures represented by the following general formulae (2) and (3). Examples of the pigment formed of a compound represented by the following general formula (2) may include C.I. Pigment Yellows 12, 13, 14, 17, 55 and 83. In addition, examples of the pigment formed of a compound represented by the following general formula (3) may include C.I. Pigment Yellows 93, 94 and 95.

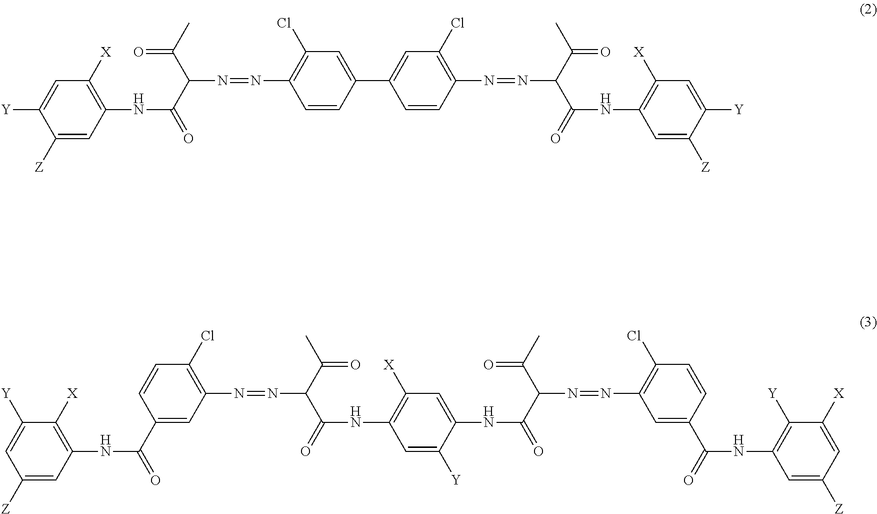

In the general formulae (2) and (3), Xs, Ys and Zs each independently represent a hydrogen atom or a monovalent substituent.

In the disazo pigment represented by the general formula (2), a moiety derived from a diazo component is present at the center of a molecule, and a moiety derived from a coupling component is present at each terminal of the molecule. In the condensed azo pigment represented by the general formula (3), a moiety derived from a coupling component is present at the center of a molecule, and a moiety derived from a diazo component is present at each terminal of the molecule. Each of the pigments has a symmetric structure of “donor-acceptor-donor” or “acceptor-donor-acceptor”, and the polarization thereof is easily canceled in the molecule. As a result, the disazo pigment and the condensed azo pigment do not easily interact with the quinacridone pigment. In addition, of the monoazo pigments, a monoazo pigment having a condensed ring in a molecule thereof does not easily interact with the quinacridone pigment due to the steric hindrance of the condensed ring.

It is conceived that the state (laminated state) of a pigment layer formed with the ink of the present invention containing the first pigment and the second pigment that specifically interact with each other is different from the laminated state of a pigment layer formed with the related-art ink. That is, it is conceived that particles of two kinds of pigments are not present in a mixed state on a recording medium, but are present on the recording medium in such a state of one particle that the two kinds of pigments are adsorbed to and combined with each other. It is conceived that such pigment layer exhibits optical characteristics that strongly reflect blue light and cancel the yellow tinge of specularly reflected light from the quinacridone pigment unlike the pigment layer formed with the related-art ink. It is conceived that such optical characteristics are caused by the influence of the refractive index of light in the pigment layer. In general, when two substances having different refractive indices are present in contact with each other, as the difference in refractive index is increased, the reflectance of light at an interface becomes higher. It is conceived that, as compared to the pigment layer formed with the related-art ink, the pigment layer formed with the ink of the present invention has a higher refractive index of blue light and a larger difference in refractive index at the interface with air having a low refractive index and hence particularly strongly reflects blue light.

The inventors have inferred the reason for the increase in refractive index of blue light in the pigment layer formed with the ink of the present invention to be as described below. In general, when light enters a substance, the electric field of the light traveling through the substance causes the oscillation of an electron in the substance. In this case, bias of electric charge occurs in the substance, and the speed of the light traveling through the substance is decreased through the action caused by the bias of electric charge. When the speed of the light traveling through the substance is decreased, the refractive index of the light in the substance is increased. In a pigment layer formed so as to include the first pigment and the second pigment in such a state of one particle that the pigments are combined with each other, a π electron in the pigment layer is attracted by the polarized second pigment, and the electron binding is strengthened. When light having a yellow wavelength enters such pigment layer, the light having a yellow wavelength has relatively low energy and is thus unlikely to oscillate the π electron in the pigment layer, resulting in a low possibility of a decrease in speed of the light in the pigment layer. Meanwhile, when light having a blue wavelength enters the pigment layer, the light has relatively high energy, and hence even the π-electron whose binding is strengthened by the combination of the first pigment and the second pigment can be oscillated. In this case, it is conceived that the speed of the blue light traveling through the pigment layer is decreased through the action of the oscillated π electron, and as a result, the refractive index of the blue light in the pigment layer is increased.

The specularly reflected light from an image recorded with an ink containing only the first pigment as a coloring material and the specularly reflected light from an image recorded with an ink containing only the second pigment as a coloring material each have a positive value of b* in the CIE L*a*b* color system and have a yellow tinge. Meanwhile, in an image recorded with an ink containing the first pigment and the second pigment, the intensity of blue specularly reflected light is increased, and the value of b* is smaller than the value of b* in each of the above-mentioned two images. That is, the combination of the first pigment and the second pigment can provide the effect of suppressing the yellow tinge of specularly reflected light, but it is difficult to predict the above-mentioned action from the characteristics of the inks containing the first pigment and the second pigment alone, respectively.

Even when an image is recorded through use of an ink containing the first pigment and another ink containing the second pigment by superimposing dots of the two inks, the effect of suppressing bronzing cannot be obtained. The reason for this is conceived as follows: when the first pigment and the second pigment are not present in one ink, the two kinds of pigments do not sufficiently interact with each other. That is, it is conceived that, merely when the dots of the two inks containing the two kinds of pigments, respectively, are superimposed on a recording medium, a pigment layer including the two kinds of pigments in such a state of one particle that the pigments are combined with each other is not formed, and the intensity of blue specularly reflected light is not increased, with the result that bronzing cannot be suppressed.

As described above, when an ink in which the first pigment and the second pigment easily interact with each other is applied to a recording medium, a pigment layer including the first pigment and the second pigment in such a state of one particle that the pigments are combined with each other is formed on the recording medium. The pigment layer strongly reflects blue light and hence easily cancels yellow specularly reflected light. Thus, the effect of suppressing bronzing can be obtained. In addition, when the ink in which the first pigment and the second pigment easily interact with each other is used, the second pigment easily acts so as to prevent the lamination of the first pigment, and hence the sticking recoverability can be improved.

### <Ink>

The ink of the present invention is an aqueous ink for ink jet including a pigment. The pigment includes a first pigment that is a quinacridone pigment and a second pigment that is a monoazo pigment free of a condensed ring in a molecule thereof. In addition, the hue angle of a diluted solution obtained by diluting the ink with water so that the absorbance at the maximum absorption wavelength in a wavelength range of from 380 nm to 780 nm is 1 is 330° or more to 345° or less. That is, the ink of the present invention is a magenta ink having a preferred magenta hue.

It has been found that, with the above-mentioned configuration, the effect of suppressing a phenomenon in which the hue (hue of magenta) of an image varies depending on the kind of a recording medium on which the image is recorded (so-called a hue deviation) can be further obtained in addition to the improvement of the sticking recoverability and bronzing resistance. Some general-purpose recording media used in an ink jet recording method each include an ink-receiving layer for keeping the coloring material in the ink in the vicinity of the surface of the recording medium. In addition, there is a recording medium, such as plain paper, which does not include an ink-receiving layer. It is conceived that the reason why a hue deviation is liable to occur when the related-art ink containing a quinacridone pigment and an azo pigment is used is that the “pigment aggregation state” and “pigment fixing position” vary depending on the presence or absence of the ink-receiving layer of the recording medium.

When an ink is applied to a recording medium including an ink-receiving layer, a liquid component in the ink quickly permeates the ink-receiving layer. The pigment concentration of the ink is rapidly increased along with the permeation of the liquid component. As a result, pigment particles are laminated on one another to form a large aggregate, and the aggregate is fixed to the recording medium. Meanwhile, when an ink is applied to a recording medium free of an ink-receiving layer, the pigment also sinks into the recording medium along with the permeation of the liquid component in the ink into the inside of the recording medium. Thus, the pigment concentration of the ink is not rapidly increased, and the pigment is easily fixed in a state of not forming an aggregate. Thus, it is conceived that, even when the same ink is used, the pigment aggregation state varies depending on the kind of the recording medium, and hence the hue of an image to be recorded is deviated.

In addition, when an image is recorded on a recording medium including an ink-receiving layer, both the quinacridone pigment and the azo pigment in the ink are fixed to the ink-receiving layer, and hence the fixing positions (positions in a depth direction) of these pigments are generally the same. Thus, the hue of the recorded image has a state in which the hues of the two kinds of pigments are equally represented. Meanwhile, when an image is recorded on a recording medium free of an ink-receiving layer, the pigments also sink into the inside of the recording medium along with the permeation of the liquid component in the ink. In this case, depending on the speed of solid-liquid separation of the pigment, a difference in pigment fixing position is caused. Thus, the hue of the pigment that is fixed to a shallower fixing position more closely to the surface of the recording medium tends to be more strongly represented. Accordingly, it is conceived that the hue of the recorded image is deviated due to the difference in pigment fixing position.

The ink of the present invention can suppress hue deviations caused by the above-mentioned differences in “pigment aggregation state” and “pigment fixing position” through use of the monoazo pigment free of a condensed ring in a molecule thereof together with the quinacridone pigment. As described above, it is conceived that, of the azo pigments, only the monoazo pigment free of a condensed ring in a molecule thereof can specifically interact with the quinacridone pigment. This interaction allows the monoazo pigment free of a condensed ring in a molecule thereof to enter between the quinacridone pigment particles and effectively suppress the aggregation of the quinacridone pigment. As a result, an aggregate of the pigment is less liable to be formed even on the recording medium including an ink-receiving layer. It is conceived that this state is similar to the fixing state of the pigment on a recording medium free of an ink-receiving layer, and hence the hue deviation caused by the difference in pigment aggregation state can be suppressed.

In addition, as described above, it is conceived that the quinacridone pigment and the monoazo pigment free of a condensed ring in a molecule thereof are brought into such a state of one particle that the pigments specifically interact to be combined with each other. When the ink is applied to a recording medium free of an ink-receiving layer, the two kinds of pigments sink into the recording medium in such a state of one particle that the pigments are combined with each other, and are eventually fixed. The two kinds of pigments brought into such a state of one particle that the pigments are combined with each other are fixed and retained at the same depth without being decomposed, and hence an image in which the hues of the two kinds of pigments are equally represented is recorded. It is conceived that, as a result of the foregoing, the hue of the image recorded on the recording medium including the ink-receiving layer and the hue of the image recorded on the recording medium free of the ink-receiving layer are less liable to be deviated. When an image is recorded through use of an ink containing the first pigment and another ink containing the second pigment by superimposing the dots of the two inks, the second pigment cannot sufficiently loosen the aggregation of the first pigment on the recording medium. Thus, the difference in pigment aggregation state on the recording medium may not be sufficiently suppressed. In addition, it is conceived that the two kinds of pigments are not easily retained at the same fixing position. As a result, the hue deviation may not be sufficiently suppressed.

Each component for forming an ink, the physical properties of the ink and the like are described below.

### (Pigment)

The ink contains a pigment as a coloring material. The pigment includes a first pigment and a second pigment. The first pigments and the second pigments may each be used alone or in combination thereof. The total content (% by mass) of pigments in the ink is preferably 0.10% by mass or more to 15.00% by mass or less, more preferably 1.00% by mass or more to 10.00% by mass or less with respect to the total mass of the ink. The content (% by mass) of the first pigment in the ink is preferably 0.05% by mass or more to 14.50% by mass or less, more preferably 1.00% by mass or more to 10.00% by mass or less with respect to the total mass of the ink. The content (% by mass) of the second pigment in the ink is preferably 0.01% by mass or more to 0.50% by mass or less, more preferably 0.02% by mass or more to 0.20% by mass or less with respect to the total mass of the ink. In addition, the total content (% by mass) of the first pigment and the second pigment in all pigments in the ink is preferably 95.00% by mass or more and may be 100.00% by mass.

### [First Pigment]

The first pigment is a quinacridone pigment. The quinacridone pigment is a pigment formed of quinacridone (5,12-dihydro-quino[2,3-b]acridine-7,14-dione) or a quinacridone derivative. The quinacridone derivative is, for example, quinacridone substituted with an alkyl group such as a methyl group, or a halogen atom such as a chlorine atom.

Specific examples of the quinacridone pigment may include: C.I. Pigment Reds 122, 192, 202, 206, 207 and 209; and C.I. Pigment Violet 19. A solid solution of two or more kinds of quinacridone pigments may be used. The solid solution is also referred to as “mixed crystal” and two or more kinds of pigments dissolve together to form a uniform solid phase as a whole. The solid solution is different from a product obtained by simply mixing the two or more kinds of pigments.

Of the above-mentioned quinacridone pigments, the first pigment is preferably a solid solution of a quinacridone pigment (quinacridone solid solution pigment). The quinacridone pigment formed of a single pigment (compound) has high crystal uniformity and is in a state in which the second pigment does not easily penetrate the quinacridone pigment. Meanwhile, the solid solution of the quinacridone pigment is a crystal formed by the penetration of two or more kinds of pigments (compounds), and distortion occurs in the arrangement in a process of crystal formation. The second pigment easily penetrates this distortion, and hence the solid solution of the quinacridone pigment more easily interacts with the second pigment as compared to the quinacridone pigment formed of a single pigment (compound). As a result, the effect of suppressing the yellow tinge of specularly reflected light, the effect of suppressing a hue deviation caused by a recording medium and the effect of improving the sticking recoverability can be further enhanced.

The solid solution of the quinacridone pigment is preferably a solid solution formed of C.I. Pigment Red 122, in which quinacridone is substituted with a methyl group and C.I. Pigment Violet 19, which is unsubstituted quinacridone. In this solid solution, the methyl group derived from C.I. Pigment Red 122 tends to be exposed to a distorted portion that has occurred in the crystal. The methyl group has a low electron density. Thus, the methyl group is easily electrically attracted to an unshared electron pair of an azo group in the second pigment, and the two kinds of pigments more easily interact with each other. As a result, the effect of suppressing the yellow tinge of specularly reflected light, the effect of suppressing a hue deviation caused by a recording medium and the effect of improving the sticking recoverability can be further enhanced.

### [Second Pigment]

The second pigment is a monoazo pigment free of a condensed ring in a molecule thereof. An azo pigment is a pigment formed of a compound having an azo group in a molecule thereof, and the compound that forms the azo pigment generally has a structure in which a diazo component that is formed by diazotizing an aromatic amine is coupled with a coupler component. The monoazo pigment is a pigment formed of an azo compound that has only one azo group in a molecule thereof. The condensed ring means a ring structure in which two or more rings are bonded to each other by sharing two or more atoms.

Specific examples of the monoazo pigment free of a condensed ring in a molecule thereof may include: C.I. Pigment Yellows 1, 3, 4, 5, 6, 9, 10, 11, 61, 62, 65, 73, 74, 75, 97, 98, 111, 116, 130, 150, 165, 168, 169, 182, 183, 190, 191 and 203; and C.I. Pigment Orange 61.

A pigment formed of a compound represented by the following general formula (1) is preferred as the second pigment. Examples of the substituent of the benzene ring may include: a nitro group; a halogen atom such as a chlorine atom; an alkoxy group having about 1 to about 4 carbon atoms, such as a methoxy group or an ethoxy group; an anionic group such as a sulfonic acid group (which may be a salt type with ammonium or an alkali metal); an acetamide group; and a sulfone anilide group (—SO₂—NH—C₆H₅). Specific examples of the compound (pigment) represented by the following general formula (1) may include C.I. Pigment Yellows 1, 3, 4, 5, 6, 9, 61, 62, 65, 73, 74, 75, 97, 98, 111, 116, 130, 168, 169 and 203. The second pigment represented by the following general formula (1) has an amide group (moiety of CONH) in a molecule thereof. This amide group forms a hydrogen bond with the carboxy group or imino group of the quinacridone pigment, with the result that the second pigment is not easily detached from the quinacridone pigment. Thus, a larger amount of a pigment particle of the first pigment and a larger amount of a pigment particle of the second pigment are easily brought into such a state of one particle that the pigments are combined with each other. As a result, the effect of suppressing the yellow tinge of specularly reflected light, the effect of suppressing a hue deviation caused by a recording medium and the effect of improving the sticking recoverability can be further enhanced.

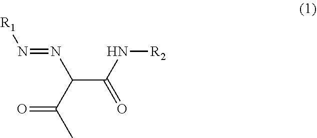

In the formula (1), R₁ and R₂ each independently represent a substituted or unsubstituted benzene ring.

The second pigment is preferably C.I. Pigment Yellow 74. C.I. Pigment Yellow 74 is a pigment having particularly high dispersion stability. When the dispersion stability of the second pigment is high, the interaction of the second pigment is small, and the second pigment is not easily aggregated. Thus, the second pigment more easily interacts with the quinacridone pigment. As a result, the second pigment is more easily brought into such a state of one particle that the pigment is combined with the quinacridone pigment, and the effect of suppressing the yellow tinge of specularly reflected light can be further enhanced. In addition, the two kinds of pigments more easily interact with each other, and hence the effect of suppressing a hue deviation caused by a recording medium and the effect of improving the sticking recoverability can be further enhanced.

The hue angle of the second pigment is preferably 85° or more to 115° or less, still more preferably 90° or more to 110° or less. The hue of the second pigment having a hue angle of less than 85° is close to a red tinge, and the specularly reflected light is easily tinged with yellow. It is conceived that part of the second pigment is present in the ink in a state of not being combined with the first pigment. When the hue angle of the second pigment is less than 85°, the yellow tinge of the specularly reflected light derived from the second pigment that is not combined with the first pigment may become strong. As a result, even when the formed pigment layer strongly reflects blue light, the yellow specularly reflected light may not be sufficiently canceled, and the effect of suppressing bronzing may not be sufficiently obtained.

Meanwhile, the hue of the second pigment having a hue angle of more than 115° comes close to green that is the complementary color of the quinacridone pigment to be used as the first pigment. When the second pigment having come close to green is mixed with a magenta pigment, the resultant becomes black and absorbs light having all wavelengths, and hence the color developability of magenta is liable to be decreased. In addition, the diffused light of the magenta pigment is absorbed by the second pigment to be reduced, and the specularly reflected light becomes more noticeable. As a result, the yellow tinge of the specularly reflected light cannot be sufficiently suppressed, and the effect of suppressing bronzing may not be sufficiently obtained.

The hue angle of the second pigment may be measured and calculated by the same procedure as that in the above-mentioned method of measuring and calculating the hue angle of an ink and a diluted solution thereof through use of a pigment dispersion liquid prepared by dispersing the second pigment in water as a sample for measurement. A surfactant and a resin do not substantially influence an absorption spectrum to be measured. Thus, the pigment dispersion liquid to be used as the sample for measurement may contain a dispersant, such as a surfactant or a resin, as required. When the ink contains two or more kinds of second pigments, that is, the ink contains a plurality of kinds of azo pigments each being free of a condensed ring in a molecule thereof, the hue angle of the second pigment is defined as a value obtained by taking the weighted average of the hue angles of the second pigments. For example, the hue angle of the second pigment when the ink contains the second pigment having a hue angle a° in an amount of b % by mass and the second pigment having a hue angle c° in an amount of d % by mass may be calculated by (a×b+c×d)/(b+d).

The content (% by mass) of the second pigment in the ink is preferably 0.005 times or more to 0.040 times or less, more preferably 0.007 times or more to 0.030 times or less, particularly preferably 0.010 times or more to 0.020 times or less in terms of mass ratio to the content (% by mass) of the first pigment. When the mass ratio is set to 0.005 times or more, the amount of the second pigment that changes the laminated state of the pigment on a recording medium becomes more sufficient, and the effect of suppressing the yellow tinge of specularly reflected light from an image can be further enhanced. In addition, the action of loosening the aggregation of the first pigment on a recording medium including an ink-receiving layer can be further enhanced. As a result, the pigment can be brought close to the fixed state of the pigment on a recording medium free of an ink-receiving layer, and hence the effect of suppressing a hue deviation can be further enhanced. Further, the lamination of the quinacridone pigment that is the first pigment is easily suppressed, and the effect of improving the sticking recoverability can be further enhanced.

In addition, when the mass ratio is set to 0.040 times or less, the interaction of the second pigment does not easily occur, and the first pigment and the second pigment are allowed to interact with each other more sufficiently. As a result, the effect of suppressing the yellow tinge of specularly reflected light from an image, the effect of suppressing a hue deviation caused by a recording medium and the effect of improving the sticking recoverability can be further enhanced.

### [Other Pigment]

The ink may contain a pigment except the first pigment and the second pigment to the extent that the effects of the present invention are not impaired. Examples of the other pigment may include inorganic pigments such as carbon black and organic pigments. The ratio of the total content (% by mass) of the first pigment and the second pigment to the total content (% by mass) of pigments in the ink is preferably 95.00% by mass or more and may be 100.00% by mass.

### [Dispersion Mode of Pigment]

Examples of the dispersion mode of the pigment may include: a resin-dispersed pigment using a resin as a dispersant; and a self-dispersible pigment having a hydrophilic group bonded to a particle surface thereof. In addition, for example, a resin-bonded pigment having an organic group containing a resin chemically bonded to a particle surface thereof or a microcapsule pigment in which the particle surface thereof is covered with or encapsulated with a resin or the like may also be used. Pigments using different dispersion methods may also be used together.

### (Resin)

The ink may contain a resin. The content (% by mass) of the resin in the ink is preferably 0.10% by mass or more to 20.00% by mass or less, more preferably 0.50% by mass or more to 15.00% by mass or less with respect to the total mass of the ink.

The resin may be added to the ink for the purpose of (i) stabilizing the dispersed state of the pigment, that is, as a resin dispersant or an aid thereof. In addition, the resin may be added to the ink for the purpose of (ii) improving various characteristics of an image to be recorded. Examples of the form of another resin may include a block copolymer, a random copolymer, a graft copolymer and a combination thereof. In addition, the other resin may be a water-soluble resin that may be dissolved in an aqueous medium or a resin particle that is dispersed in an aqueous medium. The resin particle is not required to encapsulate a coloring material.

The term “resin particle” as used herein means a resin that is present in a state of not being dissolved in an aqueous medium for forming the ink. More specifically, the term “resin particle” means a resin that may be present in an aqueous medium in a state of forming a particle whose particle diameter may be measured by a dynamic light scattering method. Meanwhile, the term “water-soluble resin” means a resin that is present in a state of being dissolved in an aqueous medium for forming the ink. More specifically, the term “water-soluble resin” means a resin that may be present in an aqueous medium in a state of not forming a particle whose particle diameter may be measured by the dynamic light scattering method. The resin particle is expressed as a counterpart to “water-soluble resin” to be “water-dispersible resin (water-insoluble resin)”.

Whether or not a resin corresponds to the “resin particle” may be determined in accordance with a method described below. First, a liquid (resin solid content: 10% by mass) containing a resin neutralized with an alkali (e.g., sodium hydroxide or potassium hydroxide) equivalent to an acid value is prepared. Next, the prepared liquid is diluted 10-fold (based on a volume) with pure water to prepare a sample solution. Then, when the particle diameter of the resin in the sample solution is measured by the dynamic light scattering method, and a particle having a particle diameter is measured, the resin may be determined to be the “resin particle”. A particle size analyzer (e.g., a product available under the product name “UPA-EX 150” from Nikkiso Co., Ltd.) or the like may be used as a particle size distribution-measuring apparatus using the dynamic light scattering method. Measurement conditions in this case may be set to, for example, SetZero: 30 seconds, number of times of measurement: 3, measurement time: 180 seconds, shape: spherical shape and refractive index: 1.59. Needless to say, the particle size distribution-measuring apparatus, the measurement conditions and the like to be used are not limited to the foregoing. The purpose of measuring the particle diameter through use of the neutralized resin is to recognize that a particle is formed even when the resin is sufficiently neutralized to make it more difficult to form a particle. The resin having a shape of a particle even under such conditions is present in a state of a particle even in an aqueous ink.

The acid value of the water-soluble resin is preferably 100 mgKOH/g or more to 250 mgKOH/g or less. The acid value of the resin for forming the resin particle is preferably 5 mgKOH/g or more to 100 mgKOH/g or less. The weight-average molecular weight of the water-soluble resin is preferably 3,000 or more to 15,000 or less. The weight-average molecular weight of the resin for forming the resin particle is preferably 1,000 or more to 2,000,000 or less. The average particle diameter (volume-based cumulative 50% particle diameter (median diameter: D₅₀) of the resin particles to be measured by the dynamic light scattering method is preferably 50 nm or more to 500 nm or less.

Examples of the resin may include an acrylic resin, a urethane-based resin and an olefin-based resin. Of those, an acrylic resin formed of a unit derived from (meth)acrylic acid or a (meth)acrylate is more preferred.

Resins each having a hydrophilic unit and a hydrophobic unit as constituent units are each preferred as the acrylic resin. Of those, a resin having a hydrophilic unit derived from (meth)acrylic acid and a hydrophobic unit derived from at least one kind selected from the group consisting of: a monomer having an aromatic ring; and a (meth)acrylic acid ester-based monomer is preferred. In particular, a resin having a hydrophilic unit derived from (meth)acrylic acid and a hydrophobic unit derived from at least one kind of monomer selected from the group consisting of: styrene; and α-methylstyrene is preferred. Those resins may each be suitably used as a resin dispersant for dispersing a pigment because of its easy interaction with the pigment.

The hydrophilic unit is a unit having a hydrophilic group such as an anionic group. The hydrophilic unit may be formed, for example, by polymerizing a hydrophilic monomer having a hydrophilic group. Specific examples of the hydrophilic monomer having a hydrophilic group include: acidic monomers having carboxylic acid groups, such as (meth)acrylic acid, itaconic acid, maleic acid and fumaric acid; and anionic monomers, such as anhydrides and salts of these acidic monomers. Examples of cations for forming the salts of the acidic monomers may include ions of lithium, sodium, potassium, ammonium and an organic ammonium. The hydrophobic unit is a unit free of a hydrophilic group such as an anionic group. The hydrophobic unit may be formed, for example, by polymerizing a hydrophobic monomer free of a hydrophilic group such as an anionic group. Specific examples of the hydrophobic monomer may include: monomers each having an aromatic ring, such as styrene, α-methylstyrene and benzyl (meth)acrylate; and (meth)acrylic acid ester-based monomers, such as methyl (meth)acrylate, butyl (meth)acrylate and 2-ethylhexyl (meth)acrylate.

The urethane-based resin may be obtained, for example, by causing a polyisocyanate and a polyol to react with each other. In addition, the urethane-based resin may be obtained by further causing a chain extender to react therewith. Examples of the olefin-based resin may include polyethylene and polypropylene.

### (Aqueous Medium)

The ink is an aqueous ink containing water or an aqueous medium that is a mixed solvent of water and a water-soluble organic solvent. Deionized water (ion-exchanged water) is preferably used as the water. The content (% by mass) of the water in the ink is preferably 50.00% by mass or more to 95.00% by mass or less with respect to the total mass of the ink. Any of solvents that may each be used in an ink for ink jet, such as alcohols, glycols, (poly)alkylene glycols, nitrogen-containing compounds and sulfur-containing compounds, may be used as the water-soluble organic solvent. The content (% by mass) of the water-soluble organic solvent in the ink is preferably 3.00% by mass or more to 50.00% by mass or less with respect to the total mass of the ink.

### (Other Components)

The ink may contain a water-soluble organic compound that is solid at 25° C., for example, a polyhydric alcohol, such as trimethylolpropane or trimethylolethane, urea or a urea derivative such as ethylene urea, as required in addition to the above-mentioned components. Further, the ink may contain any one of various additives, such as a surfactant, a pH adjuster, an antifoaming agent, a rust inhibitor, an antiseptic, an antifungal agent, an antioxidant, an anti-reducing agent and a chelating agent, as required.

### (Physical Properties of Ink)

The ink of the present invention is an aqueous ink to be applied to an ink jet system. Thus, it is preferred that the physical property values thereof be appropriately controlled from the viewpoint of reliability. The dynamic surface tension γ₁₀ of the ink at a lifetime of 10 milliseconds under the temperature condition of 25° C. is preferably 35.0 mN/m or more to 50.0 mN/m or less, more preferably 40.0 mN/m or more to 50.0 mN/m or less. An ink having a dynamic surface tension γ₁₀ of 35.0 mN/m or more takes time to penetrate a recording medium. Thus, even when the ink is applied to a recording medium free of an ink-receiving layer (recording medium having high permeability), the time for the first pigment and the second pigment to interact with each other can be sufficiently ensured. As a result, even when an image is recorded on a recording medium free of an ink-receiving layer, the difference in fixing position is less liable to occur between the first pigment and the second pigment, and the hue deviation from an image recorded on a recording medium including an ink-receiving layer is less liable to occur.

Meanwhile, when an ink having a dynamic surface tension γ₁₀ of 50.0 mN/m or less is used, the dot height of a pigment layer to be formed on a recording medium does not become too high, and the irregularities of the surface of the pigment layer are reduced. Thus, the scattering of light on the surface of the pigment layer can be suppressed. The scattering of light is more liable to occur with blue light having a short wavelength. Blue specularly reflected light that cancels yellow-tinged specularly reflected light is scattered before reaching an observer when the irregularities of the pigment layer are large, with the result that the effect of suppressing bronzing of a yellow tinge may not be sufficiently obtained. Thus, when the ink having a dynamic surface tension γ₁₀ of 50.0 mN/m or less is used, blue specularly reflected light is less liable to be lost by scattering, and the effect of suppressing bronzing can be further enhanced.

The dynamic surface tension of the ink is measured with a dynamic surface tension meter (e.g., a product available under the product name “BUBBLE PRESSURE TENSIOMETER BP100” from KRUSS) using a maximum bubble pressure method. The maximum bubble pressure method is a method involving measuring the maximum pressure required for releasing bubbles generated at the distal end of a probe (capillary) immersed in a liquid to be measured and determining the surface tension of the liquid from the measured maximum pressure. Specifically, the maximum pressure is measured while bubbles are continuously generated at the distal end of the probe. A period of time from the time point at which a new bubble surface appears at the distal end of the probe to the time point at which the maximum bubble pressure (time at which the radius of curvature of the bubble becomes equal to the radius of the distal end portion of the probe) is achieved is referred to as “lifetime”. That is, the maximum bubble pressure method is a method of measuring the surface tension of a liquid in a state of motion. The dynamic surface tension γ₁₀ of the ink at a lifetime of 10 milliseconds may be easily adjusted by the kinds and contents of a water-soluble organic solvent and a surfactant.

The static surface tension γₛ of the ink at 25° C. is preferably 25.0 mN/m or more to 40.0 mN/m or less. The static surface tension of the ink is measured with a Wilhelmy-type surface tension meter (e.g., a product available under the product name “Automatic Surface Tension Meter CBVP-Z” from Kyowa Interface Science Co., Ltd.).

The pH of the ink at 25° C. is preferably 5.0 or more to 10.0 or less, more preferably 7.0 or more to 9.5 or less. The pH of the ink is measured with a general pH meter having a glass electrode and the like mounted thereon.

The viscosity of the ink at 25° C. is preferably 1.0 mPa·s or more to 5.0 mPa·s or less. The viscosity of the ink is measured with a viscometer (e.g., a product available under the product name “RE80 viscometer” from Toki Sangyo Co., Ltd.).

### <Ink Cartridge>

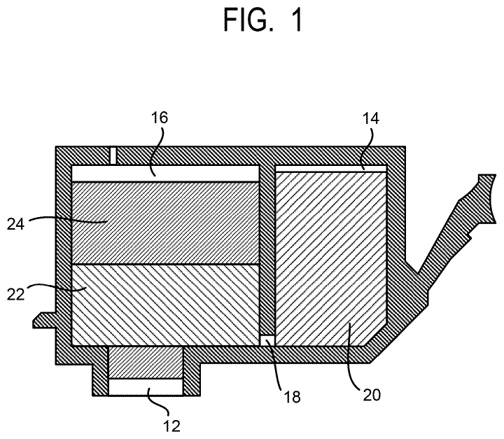

An ink cartridge of the present invention includes an ink and an ink storage portion that stores the ink. In addition, the ink stored in the ink storage portion is the aqueous ink of the present invention described above. FIG. 1 is a sectional view for schematically illustrating an ink cartridge according to one embodiment of the present invention. As illustrated in FIG. 1, an ink supply port 12 for supplying an ink to a recording head is arranged on the bottom surface of the ink cartridge. The inside of the ink cartridge is the ink storage portion for storing the ink. The ink storage portion includes an ink storage chamber 14 and an absorbent storage chamber 16 and the chambers communicate to each other through a communication port 18. In addition, the absorbent storage chamber 16 communicates to the ink supply port 12. While a liquid ink 20 is stored in the ink storage chamber 14, absorbents 22 and 24 each of which holds the ink in a state of being impregnated therewith are stored in the absorbent storage chamber 16. The ink storage portion may be configured to be free of an ink storage chamber that stores the liquid ink and to hold the total amount of the ink to be stored with the absorbents. In addition, the ink storage portion may be configured to be free of an absorbent and to store the total amount of the ink in a liquid state. Further, an ink cartridge configured to include the ink storage portion and a recording head may be adopted.

### <Ink Jet Recording Method>

An ink jet recording method of the present invention is a method including ejecting the aqueous ink of the present invention described above from a recording head of an ink jet system to record an image on a recording medium. A system of ejecting the ink is, for example, a system involving applying mechanical energy to the ink or a system involving applying thermal energy to the ink. In the present invention, the system involving applying the thermal energy to the ink to eject the ink is particularly preferably adopted. The step of the ink jet recording method only needs to be a known step except that the ink of the present invention is used.

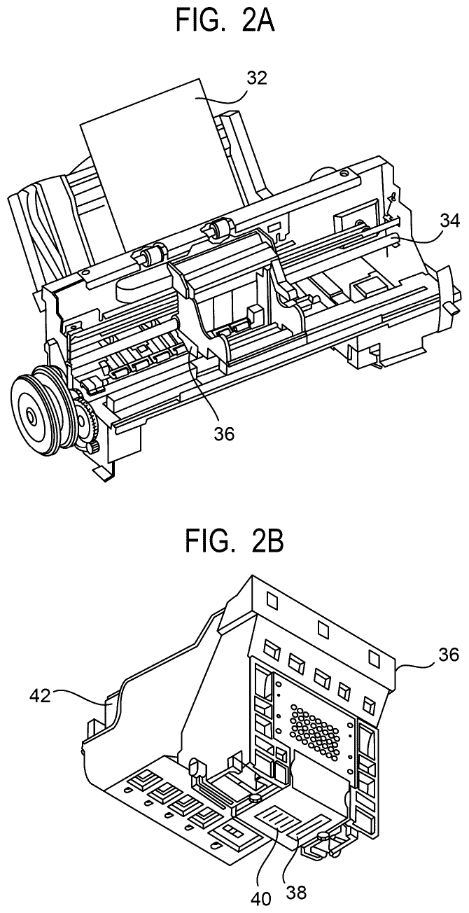

FIG. 2A and FIG. 2B are views for schematically illustrating an example of an ink jet recording apparatus to be used in the ink jet recording method of the present invention, in which FIG. 2A is a perspective view of the main portion of the ink jet recording apparatus and FIG. 2B is a perspective view of a head cartridge. A conveying unit (not shown) that conveys a recording medium 32 and a carriage shaft 34 are arranged in the ink jet recording apparatus. A head cartridge 36 may be mounted on the carriage shaft 34. The head cartridge 36 includes recording heads 38 and 40 and is formed so that an ink cartridge 42 may be set therein. While the head cartridge 36 is conveyed along the carriage shaft 34 in a main scanning direction, the ink (not shown) is ejected from the recording heads 38 and 40 toward the recording medium 32. Then, the recording medium 32 is conveyed by the conveying unit (not shown) in a sub-scanning direction. Thus, the image is recorded on the recording medium 32.

According to the present invention, there can be provided an aqueous ink for ink jet, which is excellent in sticking recoverability and capable of suppressing bronzing. In addition, according to the present invention, there can be provided an ink cartridge and an ink jet recording method each using the aqueous ink.

### EXAMPLES

The present invention is described in more detail below by way of Examples and Comparative Examples. However, the present invention is by no means limited to Examples below, and various modifications are possible without departing from the gist of the present invention. In the description of the amounts of components, “part(s)” and “%” are by mass unless otherwise specified.

### <Methods of Measuring Physical Property Values>

### (Hue Angle)

The hue angle of the diluted solution of an ink was measured and calculated in accordance with the following procedure. First, the ink was diluted with ion-exchanged water so that the absorbance at the maximum absorption wavelength in a wavelength range of from 380 nm to 780 nm was 1 to provide a diluted solution. Then, the resultant diluted solution was loaded into a quartz glass cell having an optical path length of 10 mm, and its absorption spectrum in a wavelength region of from 200 nm to 800 nm was measured with a spectrophotometer. A product available under the product name “Spectrophotometer U-3900H” from by Hitachi High-Tech Corporation was used as the spectrophotometer. Peak detection conditions in the measurement of the absorption spectrum were set to a sampling interval of 0.5 nm, a threshold value of 0.01 and a sensitivity of 1. In addition, ion-exchanged water was used as a reference. From the measured absorption spectrum of the diluted solution, L*, a* and b* in the L*a*b* color system were calculated under the conditions of a light source C and a field of view of 2°. A hue angle “h” in the L*C*h color system was calculated by h=tan⁻¹(b*/a*).

### <Preparation of Resin>

### (Aqueous Solution of Resin 1)

A styrene/n-butyl acrylate/acrylic acid copolymer (copolymerization ratio (mass ratio): 60:20:20) synthesized by an ordinary method was prepared as a resin 1. The resin 1 was dissolved in water containing potassium hydroxide in an equimolar amount to its acid value to prepare an aqueous solution of the resin 1 in which the content of the resin 1 was 20.00%.

### (Solution of Resin 2)

A flask including a stirring machine, a reflux tube, a temperature gauge and a dropping funnel was prepared, and the inside of the flask was purged with nitrogen. 20 g of styrene, 2 g of acrylic acid and 10 g of butyl methacrylate were loaded into the flask and heated to 70° C. Next, a mixed liquid of 100 g of styrene, 5 g of acrylic acid, 50 g of butyl methacrylate and 1.5 g of azobisdimethylvaleronitrile was dropped into the flask over 3 hours to cause polymerization. Further, a mixed liquid of 8 g of azobisisovaleronitrile and 30 g of methyl ethyl ketone was added over 1 hour to accelerate the polymerization. After the completion of the reaction, 200 g of methyl ethyl ketone was added to prepare a solution of a resin 2 in which the content of the resin 2 was 20.00%.

### <Preparation of Pigment>

### (Pigments 1 to 10)

Pigments shown in Table 1 were used as pigments 1 to 10. The structures of the pigments and whether or not the pigments are solid solutions are summarized in Table 1. The symbol “Yes” shown in the column “Solid solution” means that the pigment is a solid solution, and the symbol “No” shown therein means that the pigment is not a solid solution. The pigments 1 to 4 were each obtained by: grinding a press cake formed by mixing C.I. Pigment Red 122 and C.I. Pigment Violet 19 at a ratio (based on a mass) shown in Table 1; and then treating the ground press cake with an organic solvent in accordance with an ordinary method to form a solid solution pigment. C.I. Pigment Violet 207, which was a solid solution pigment of C.I. Pigment Violet 19 and 4,11-dichloroquinacridonequinone, was used as the pigment 7. A commercial product (available under the product name “Cromophtal Jet Magenta 2BC” from Ciba Specialty Chemicals), which was a solid solution pigment of C.I. Pigment Red 202 and C.I. Pigment Violet 19 was used as the pigment 8.

TABLE 1
Kind of pigment

| | | | Solid |
|---|---|---|---|
| Pigment | Kind | Structure | solution |
| 1 | C.I. Pigment Red 122/C.I. | Quinacridone | Yes |
| | Pigment Violet 19 (8:2) | | |
| 2 | C.I. Pigment Red 122/C.I. | Quinacridone | Yes |
| | Pigment Violet 19 (5:5) | | |
| 3 | C.I. Pigment Red 122/C.I. | Quinacridone | Yes |
| | Pigment Violet 19 (9:1) | | |
| 4 | C.I. Pigment Red 122/C.I. | Quinacridone | Yes |
| | Pigment Violet 19 (1:9) | | |
| 5 | C.I. Pigment Red 122 | Quinacridone | No |
| 6 | C.I. Pigment Violet 19 | Quinacridone | No |
| 7 | C.I. Pigment Violet 207 | Quinacridone | Yes |
| 8 | C.I. Pigment Red 202/C.I. | Quinacridone | Yes |
| | Pigment Violet 19 | | |
| 9 | C.I. Pigment Red 177 | Anthraquinone | — |
| 10 | C.I. Pigment Red 254 | Diketopyrrolopyrrole | — |

### (Pigments 11 to 21)

Pigments shown in Table 2 were used as pigments 11 to 21. A hue angle (s) the presence or absence of a condensed ring and whether or not the pigment corresponds to the compound represented by the general formula (1) are shown in Table 2. The symbol “Yes” shown in the column “Condensed ring” means that the pigment is a pigment having a condensed ring in a molecule thereof, and the symbol “No” shown therein means that the pigment is a pigment free of a condensed ring in a molecule thereof. The symbol “Yes” shown in the column “General formula (1)” means that the pigment is the compound represented by the general formula (1), and the symbol “No” shown therein means that the pigment is not the compound represented by the general formula (1)

TABLE 2
Kind of pigment

| | | | | Condensed | General |
|---|---|---|---|---|---|
| | | | Hue angle | ring in | formula |
| Pigment | Kind | Structure | (°) | molecule | (1) |
| 11 | C.I. Pigment | Monoazo | 295 | Yes | No |
| | Red 150 | | | | |
| 12 | C.I. Pigment | Monoazo | 101 | No | Yes |
| | Yellow 74 | | | | |
| 13 | C.I. Pigment | Monoazo | 116 | No | Yes |
| | Yellow 3 | | | | |
| 14 | C.I. Pigment | Monoazo | 84 | No | Yes |
| | Yellow 65 | | | | |
| 15 | C.I. Pigment | Monoazo | 93 | No | No |
| | Yellow 183 | | | | |
| 16 | C.I. Pigment | Monoazo | 90 | No | No |
| | Yellow 150 | | | | |
| 17 | C.I. Pigment | Monoazo | 90 | No | Yes |
| | Yellow 97 | | | | |
| 18 | C.I. Pigment | Monoazo | 92 | No | Yes |
| | Yellow 98 | | | | |
| 19 | C.I. Pigment | Disazo | 105 | No | Yes |
| | Yellow 155 | | | | |
| 20 | C.I. Pigment | Condensed | 109 | No | Yes |
| | Yellow 128 | azo | | | |
| 21 | C.I. Pigment | Disazo | 93 | Yes | Yes |
| | Yellow 180 | | | | |

### <Preparation of Pigment Dispersion Liquid>

### (Pigment Dispersion Liquids 1 to 10 and 13 to 22)

10.0 Parts of each pigment of the kind shown in Table 3, 10.0 parts of the aqueous solution of the resin 1 and 80.0 parts of ion-exchanged water were mixed, and the mixture was subjected to dispersion treatment with a batch-type vertical sand mill for 3 hours to provide a dispersion liquid. The resultant dispersion liquid was filtered under pressure with a filter (product available under the product name “HDC II” from Nihon Pall Ltd.) having a pore size of 2.5 μm. An appropriate amount of ion-exchanged water was added to the dispersion liquid to prepare each of pigment dispersion liquids 1 to 10 and 13 to 22 in which the contents of a pigment and a resin (resin dispersant) were shown in Table 3.

TABLE 3
Conditions for preparation of pigment dispersion
liquids and their characteristics

| | |
|---|---|
| Pigment | Content (%) |

| dispersion liquid | Kind of pigment | Pigment | Resin |
|---|---|---|---|
| 1 | 1 | 10.00 | 2.00 |
| 2 | 2 | 10.00 | 2.00 |
| 3 | 3 | 10.00 | 2.00 |
| 4 | 4 | 10.00 | 2.00 |
| 5 | 5 | 10.00 | 2.00 |
| 6 | 6 | 10.00 | 2.00 |
| 7 | 7 | 10.00 | 2.00 |
| 8 | 8 | 10.00 | 2.00 |
| 9 | 9 | 10.00 | 2.00 |
| 10 | 10 | 10.00 | 2.00 |
| 13 | 11 | 10.00 | 2.00 |
| 14 | 12 | 10.00 | 2.00 |
| 15 | 13 | 10.00 | 2.00 |
| 16 | 14 | 10.00 | 2.00 |
| 17 | 15 | 10.00 | 2.00 |
| 18 | 16 | 10.00 | 2.00 |
| 19 | 17 | 10.00 | 2.00 |
| 20 | 18 | 10.00 | 2.00 |
| 21 | 19 | 10.00 | 2.00 |
| 22 | 20 | 10.00 | 2.00 |

### (Pigment Dispersion Liquid 11)

30.0 Parts of the solution of the resin 2, 30.0 parts of the pigment 5 (C.I. Pigment Red 122) and 50.0 parts of a 0.1 mol/L sodium hydroxide aqueous solution were stirred with a homogenizer to provide a mixture. 500 Parts of ion-exchanged water was added to the resultant mixture, followed by further stirring. Methyl ethyl ketone and part of the ion-exchanged water were evaporated with an evaporator to provide a pigment dispersion liquid 11 containing the pigment included in the resin 2 in which the content of the pigment was 20.00% and the content of the resin 2 was 4.00%.

### (Pigment Dispersion Liquid 12)

15.0 Parts of the pigment 5 (C.I. Pigment Red 122), 5.0 parts of ammonium polyoxyethylene lauryl ether sulfate (number of moles added of ethylene oxide groups: 12), 15.0 parts of glycerin and 65.0 parts of ion-exchanged water were mixed to provide a mixture. The resultant mixture was loaded into a wet sand mill using zirconia beads each having a diameter of 0.3 mm as a medium and subjected to dispersion treatment to provide a pigment dispersion liquid 12 in which the content of the pigment was 15.00% and the content of the dispersant (surfactant) was 5.00%.

### (Pigment Dispersion Liquid 23)

A pigment dispersion liquid 23 containing the pigment included in the resin 2 in which the content of the pigment was 20.00% and the content of the resin 2 was 4.00% was obtained in the same manner as in the case of the pigment dispersion liquid 11 described above except that the pigment 21 (C.I. Pigment Yellow 180) was used instead of the pigment 5.

### (Pigment Dispersion Liquid 24)

A pigment dispersion liquid 24 in which the content of the pigment was 15.00% and the content of the dispersant (surfactant) was 5.0% was obtained in the same manner as in the case of the pigment dispersion liquid 12 described above except that the pigment 12 (C.I. Pigment Yellow 74) was used instead of the pigment 5.

### <Preparation of Ink>

Respective components (unit: %) shown in the middle section of Tables 4-1 to 4-6 were mixed and thoroughly stirred. After that, the mixture was filtered under pressure with a polypropylene filter (manufactured by Advantec) having a pore size of 1.0 μm to prepare inks 1 to 42. In the preparation of each of the inks, the usage amount of a nonionic surfactant was adjusted so that the dynamic surface tension (γ₁₀ (mN/m)) of the ink at a lifetime of 10 milliseconds was a value shown in the lower section of Tables 4-1 to 4-6. A product available under the product name “Acetylenol E100” from Kawaken Fine Chemicals Co., Ltd. was used as the nonionic surfactant. The usage amount of the nonionic surfactant is shown in the row “Ion-exchanged water containing Acetylenol E100” in Tables 4-1 to 4-6 as the usage amount contained in ion-exchanged water. “Proxel GXL(S)” is the product name of a preservative available from Arch Chemicals, Inc.

The characteristics of the prepared inks are shown in the lower section of Tables 4-1 to 4-6. The dynamic surface tension (γ₁₀ (mN/m)) of each ink at a lifetime of 10 milliseconds was measured with a dynamic surface tension meter using a maximum bubble pressure method under the condition of 25° C. A product available under the product name “BUBBLE PRESSURE TENSIOMETER BP-100” from KRUSS was used as the dynamic surface tension meter. The hue angle of a diluted solution obtained by diluting the ink with water so that the absorbance at the maximum absorption wavelength in a wavelength range of from 380 nm to 780 nm calculated by the above-mentioned method was 1 is shown in the row “Hue angle of diluted solution h (°)”. When such diluted solution is prepared, and the hue angle thereof is measured, evaluation can be made with the same indicator even in different kinds of pigments. In addition, when the absorbance is set to 1, the accuracy of the measurement can be enhanced.

TABLE 4-1
Composition and characteristics of ink

| | Ink | | | | | | |
|---|---|---|---|---|---|---|---|
| | 1 | 2 | 3 | 4 | 5 | 6 | 7 |
| Pigment dispersion liquid 1 | 40.00 | 40.00 | | | | | |
| Pigment dispersion liquid 2 | | | 40.00 | | | | 40.00 |
| Pigment dispersion liquid 3 | | | | 40.00 | | 40.00 | |
| Pigment dispersion liquid 4 | | | | | 40.00 | | |
| Pigment dispersion liquid 5 | | | | | | | |
| Pigment dispersion liquid 6 | | | | | | | |
| Pigment dispersion liquid 7 | | | | | | | |
| Pigment dispersion liquid 8 | | | | | | | |
| Pigment dispersion liquid 9 | | | | | | | |
| Pigment dispersion liquid 10 | | | | | | | |
| Pigment dispersion liquid 11 | | | | | | | |
| Pigment dispersion liquid 12 | | | | | | | |
| Pigment dispersion liquid 13 | | | | | | | |
| Pigment dispersion liquid 14 | 0.50 | 0.50 | 0.50 | 0.50 | 0.50 | 0.22 | 1.54 |
| Pigment dispersion liquid 15 | | | | | | | |
| Pigment dispersion liquid 16 | | | | | | | |
| Pigment dispersion liquid 17 | | | | | | | |
| Pigment dispersion liquid 18 | | | | | | | |
| Pigment dispersion liquid 19 | | | | | | | |
| Pigment dispersion liquid 20 | | | | | | | |
| Pigment dispersion liquid 21 | | | | | | | |
| Pigment dispersion liquid 22 | | | | | | | |
| Pigment dispersion liquid 23 | | | | | | | |
| Pigment dispersion liquid 24 | | | | | | | |
| Aqueous solution of resin 1 | 7.50 | | 7.50 | 7.50 | 7.50 | 7.50 | 7.50 |
| Glycerin | 10.00 | 10.00 | 10.00 | 10.00 | 10.0 | 10.00 | 10.00 |
| Thiodiglycol | | | | | | | |
| Triethylene glycol | | | | | | | |
| monobutyl ether | | | | | | | |
| 1,5-Pentanediol | | | | | | | |
| Dipropylene glycol-n-propyl | | | | | | | |
| ether | | | | | | | |
| Triethanolamine | | | | | | | |
| OLFINE E1010 | | | | | | | |
| Proxel GXL(S) | 0.05 | 0.05 | 0.05 | 0.05 | 0.05 | 0.05 | 0.05 |
| Ion-exchanged water | 41.95 | 49.45 | 41.95 | 41.95 | 41.95 | 42.23 | 40.91 |
| containing Acetylenol E100 | | | | | | | |
| Content Q (%) of first | 4.00 | 4.00 | 4.00 | 4.00 | 4.00 | 4.00 | 4.00 |
| pigment | | | | | | | |
| Content A (%) of second | 0.05 | 0.05 | 0.05 | 0.05 | 0.05 | 0.02 | 0.15 |
| pigment | | | | | | | |
| Value (times) of A/Q | 0.013 | 0.013 | 0.013 | 0.013 | 0.013 | 0.005 | 0.038 |
| Hue angle “h (°)” of diluted | 337 | 337 | 338 | 335 | 338 | 330 | 345 |
| solution | | | | | | | |
| Hue angle (°) of second | 101 | 101 | 101 | 101 | 101 | 101 | 101 |
| pigment | | | | | | | |
| γ₁₀ (mN/m) | 45.0 | 45.0 | 45.0 | 45.0 | 45.0 | 45.0 | 45.0 |

TABLE 4-2
Composition and characteristics of ink

| | Ink | | | | | | |
|---|---|---|---|---|---|---|---|
| | 8 | 9 | 10 | 11 | 12 | 13 | 14 |
| Pigment dispersion liquid 1 | 40.00 | 40.00 | 40.00 | 40.00 | 40.00 | 40.00 | 40.00 |
| Pigment dispersion liquid 2 | | | | | | | |
| Pigment dispersion liquid 3 | | | | | | | |
| Pigment dispersion liquid 4 | | | | | | | |
| Pigment dispersion liquid 5 | | | | | | | |
| Pigment dispersion liquid 6 | | | | | | | |
| Pigment dispersion liquid 7 | | | | | | | |
| Pigment dispersion liquid 8 | | | | | | | |
| Pigment dispersion liquid 9 | | | | | | | |
| Pigment dispersion liquid 10 | | | | | | | |
| Pigment dispersion liquid 11 | | | | | | | |
| Pigment dispersion liquid 12 | | | | | | | |
| Pigment dispersion liquid 13 | | | | | | | |
| Pigment dispersion liquid 14 | 0.16 | 0.20 | 1.60 | 1.70 | 0.50 | 0.50 | 0.50 |
| Pigment dispersion liquid 15 | | | | | | | |
| Pigment dispersion liquid 16 | | | | | | | |
| Pigment dispersion liquid 17 | | | | | | | |
| Pigment dispersion liquid 18 | | | | | | | |
| Pigment dispersion liquid 19 | | | | | | | |
| Pigment dispersion liquid 20 | | | | | | | |
| Pigment dispersion liquid 21 | | | | | | | |
| Pigment dispersion liquid 22 | | | | | | | |
| Pigment dispersion liquid 23 | | | | | | | |
| Pigment dispersion liquid 24 | | | | | | | |
| Aqueous solution of resin 1 | 7.50 | 7.50 | 7.50 | 7.50 | 7.50 | 7.50 | 7.50 |
| Glycerin | 10.00 | 10.00 | 10.00 | 10.00 | 10.00 | 10.00 | 10.00 |
| Thiodiglycol | | | | | | | |
| Triethylene glycol | | | | | | | |
| monobutyl ether | | | | | | | |
| 1,5-Pentanediol | | | | | | | |
| Dipropylene glycol-n-propyl | | | | | | | |
| ether | | | | | | | |
| Triethanolamine | | | | | | | |
| OLFINE E1010 | | | | | | | |
| Proxel GXL(S) | 0.05 | 0.05 | 0.05 | 0.05 | 0.05 | 0.05 | 0.05 |
| Ion-exchanged water | 42.29 | 42.25 | 40.85 | 40.75 | 41.95 | 41.95 | 41.95 |
| containing Acetylenol E100 | | | | | | | |
| Content Q (%) of first | 4.00 | 4.00 | 4.00 | 4.00 | 4.00 | 4.00 | 4.00 |
| pigment | | | | | | | |
| Content A (%) of second | 0.016 | 0.02 | 0.16 | 0.17 | 0.05 | 0.05 | 0.05 |
| pigment | | | | | | | |
| Value (times) of A/Q | 0.004 | 0.005 | 0.040 | 0.043 | 0.013 | 0.013 | 0.013 |
| Hue angle “h (°)” of diluted | 335 | 336 | 340 | 341 | 337 | 337 | 337 |
| solution | | | | | | | |
| Hue angle (°) of second | 101 | 101 | 101 | 101 | 101 | 101 | 101 |
| pigment | | | | | | | |
| γ₁₀ (mN/m) | 45.0 | 45.0 | 45.0 | 45.0 | 34.0 | 35.0 | 50.0 |

TABLE 4-3
Composition and characteristics of ink

| | Ink | | | | | | |
|---|---|---|---|---|---|---|---|
| | 15 | 16 | 17 | 18 | 19 | 20 | 21 |
| Pigment dispersion liquid 1 | 40.00 | | | | | 40.00 | 40.00 |
| Pigment dispersion liquid 2 | | | | | | | |
| Pigment dispersion liquid 3 | | | | | | | |
| Pigment dispersion liquid 4 | | | | | | | |
| Pigment dispersion liquid 5 | | 40.00 | | | | | |
| Pigment dispersion liquid 6 | | | 40.00 | | | | |
| Pigment dispersion liquid 7 | | | | 40.00 | | | |
| Pigment dispersion liquid 8 | | | | | 40.00 | | |
| Pigment dispersion liquid 9 | | | | | | | |
| Pigment dispersion liquid 10 | | | | | | | |
| Pigment dispersion liquid 11 | | | | | | | |
| Pigment dispersion liquid 12 | | | | | | | |
| Pigment dispersion liquid 13 | | | | | | | |
| Pigment dispersion liquid 14 | 0.50 | 0.50 | 0.50 | 0.50 | 0.50 | | 0.08 |
| Pigment dispersion liquid 15 | | | | | | | |
| Pigment dispersion liquid 16 | | | | | | 0.50 | 0.42 |
| Pigment dispersion liquid 17 | | | | | | | |
| Pigment dispersion liquid 18 | | | | | | | |
| Pigment dispersion liquid 19 | | | | | | | |
| Pigment dispersion liquid 20 | | | | | | | |
| Pigment dispersion liquid 21 | | | | | | | |
| Pigment dispersion liquid 22 | | | | | | | |
| Pigment dispersion liquid 23 | | | | | | | |
| Pigment dispersion liquid 24 | | | | | | | |
| Aqueous solution of resin 1 | 7.50 | 7.50 | 7.50 | 7.50 | 7.50 | 7.50 | 7.50 |
| Glycerin | 10.00 | 10.00 | 10.00 | 10.00 | 10.00 | 10.00 | 10.00 |
| Thiodiglycol | | | | | | | |
| Triethylene glycol | | | | | | | |
| monobutyl ether | | | | | | | |
| 1,5-Pentanediol | | | | | | | |
| Dipropylene glycol-n-propyl | | | | | | | |
| ether | | | | | | | |
| Triethanolamine | | | | | | | |
| OLFINE E1010 | | | | | | | |
| Proxel GXL(S) | 0.05 | 0.05 | 0.05 | 0.05 | 0.05 | 0.05 | 0.05 |
| Ion-exchanged water | 41.95 | 41.95 | 41.95 | 41.95 | 41.95 | 41.95 | 41.95 |
| containing Acetylenol E100 | | | | | | | |
| Content Q (%) of first | 4.00 | 4.00 | 4.00 | 4.00 | 4.00 | 4.00 | 4.00 |
| pigment | | | | | | | |
| Content A (%) of second | 0.05 | 0.05 | 0.05 | 0.05 | 0.05 | 0.05 | 0.05 |
| pigment | | | | | | | |
| Value (times) of A/Q | 0.013 | 0.013 | 0.013 | 0.013 | 0.013 | 0.013 | 0.013 |
| Hue angle “h (°)” of diluted | 337 | 337 | 337 | 337 | 341 | 336 | 337 |
| solution | | | | | | | |
| Hue angle (°) of second | 101 | 101 | 101 | 101 | 101 | 84 | 85 |
| pigment | | | | | | | |
| γ₁₀ (mN/m) | 51.0 | 45.0 | 45.0 | 45.0 | 45.0 | 45.0 | 45.0 |

TABLE 4-4
Composition and characteristics of ink

| | Ink | | | | | | |
|---|---|---|---|---|---|---|---|
| | 22 | 23 | 24 | 25 | 26 | 27 | 28 |
| Pigment dispersion liquid 1 | 40.00 | 40.00 | 40.00 | 40.00 | 40.00 | 40.00 | |
| Pigment dispersion liquid 2 | | | | | | | |
| Pigment dispersion liquid 3 | | | | | | | |
| Pigment dispersion liquid 4 | | | | | | | |
| Pigment dispersion liquid 5 | | | | | | | |
| Pigment dispersion liquid 6 | | | | | | | |
| Pigment dispersion liquid 7 | | | | | | | |
| Pigment dispersion liquid 8 | | | | | | | |
| Pigment dispersion liquid 9 | | | | | | | 40.00 |
| Pigment dispersion liquid 10 | | | | | | | |
| Pigment dispersion liquid 11 | | | | | | | |
| Pigment dispersion liquid 12 | | | | | | | |
| Pigment dispersion liquid 13 | | | | | | | |
| Pigment dispersion liquid 14 | 0.08 | | | | | | 0.50 |
| Pigment dispersion liquid 15 | 0.42 | 0.50 | | | | | |
| Pigment dispersion liquid 16 | | | | | | | |
| Pigment dispersion liquid 17 | | | 0.50 | | | | |
| Pigment dispersion liquid 18 | | | | 0.50 | | | |
| Pigment dispersion liquid 19 | | | | | 0.50 | | |
| Pigment dispersion liquid 20 | | | | | | 0.50 | |
| Pigment dispersion liquid 21 | | | | | | | |
| Pigment dispersion liquid 22 | | | | | | | |
| Pigment dispersion liquid 23 | | | | | | | |
| Pigment dispersion liquid 24 | | | | | | | |
| Aqueous solution of resin 1 | 7.50 | 7.50 | 7.50 | 7.50 | 7.50 | 7.50 | 7.50 |
| Glycerin | 10.00 | 10.00 | 10.00 | 10.00 | 10.00 | 10.00 | 10.00 |
| Thiodiglycol | | | | | | | |
| Triethylene glycol | | | | | | | |
| monobutyl ether | | | | | | | |
| 1,5-Pentanediol | | | | | | | |
| Dipropylene glycol-n-propyl | | | | | | | |
| ether | | | | | | | |
| Triethanolamine | | | | | | | |
| OLFINE E1010 | | | | | | | |
| Proxel GXL(S) | 0.05 | 0.05 | 0.05 | 0.05 | 0.05 | 0.05 | 0.05 |
| Ion-exchanged water | 41.95 | 41.95 | 41.95 | 41.95 | 41.95 | 41.95 | 41.95 |
| containing Acetylenol E100 | | | | | | | |
| Content Q (%) of first | 4.00 | 4.00 | 4.00 | 4.00 | 4.00 | 4.00 | — |
| pigment | | | | | | | |
| Content A (%) of second | 0.05 | 0.05 | 0.05 | 0.05 | 0.05 | 0.05 | 0.05 |
| pigment | | | | | | | |
| Value (times) of A/Q | 0.013 | 0.013 | 0.013 | 0.013 | 0.013 | 0.013 | — |
| Hue angle “h (°)” of diluted | 338 | 338 | 336 | 337 | 337 | 337 | 4 |
| solution | | | | | | | |
| Hue angle (°) of second | 115 | 116 | 93 | 90 | 90 | 92 | 101 |
| pigment | | | | | | | |
| γ₁₀ (mN/m) | 45.0 | 45.0 | 45.0 | 45.0 | 45.0 | 45.0 | 45.0 |

TABLE 4-5
Composition and characteristics of ink

| | Ink | | | | | | |
|---|---|---|---|---|---|---|---|
| | 29 | 30 | 31 | 32 | 33 | 34 | 35 |
| Pigment dispersion liquid 1 | | | 40.00 | 40.00 | 40.00 | 40.00 | |
| Pigment dispersion liquid 2 | | | | | | | |
| Pigment dispersion liquid 3 | | | | | | | 40.00 |
| Pigment dispersion liquid 4 | | | | | | | |
| Pigment dispersion liquid 5 | | | | | | | |
| Pigment dispersion liquid 6 | | | | | | | |
| Pigment dispersion liquid 7 | | | | | | | |
| Pigment dispersion liquid 8 | | | | | | | |
| Pigment dispersion liquid 9 | | | | | | | |
| Pigment dispersion liquid 10 | 40.00 | | | | | | |
| Pigment dispersion liquid 11 | | | | | | | |
| Pigment dispersion liquid 12 | | | | | | | |
| Pigment dispersion liquid 13 | | 40.00 | | | | 0.50 | |
| Pigment dispersion liquid 14 | 0.50 | 0.50 | | | | | 0.004 |
| Pigment dispersion liquid 15 | | | | | | | |
| Pigment dispersion liquid 16 | | | | | | | |
| Pigment dispersion liquid 17 | | | | | | | |
| Pigment dispersion liquid 18 | | | | | | | |
| Pigment dispersion liquid 19 | | | | | | | |
| Pigment dispersion liquid 20 | | | | | | | |
| Pigment dispersion liquid 21 | | | | 0.50 | | | |
| Pigment dispersion liquid 22 | | | | | 0.50 | | |
| Pigment dispersion liquid 23 | | | | | | | |
| Pigment dispersion liquid 24 | | | | | | | |
| Aqueous solution of resin 1 | 7.50 | 7.50 | 7.50 | 7.50 | 7.50 | 7.50 | 7.50 |
| Glycerin | 10.00 | 10.00 | 10.00 | 10.00 | 10.00 | 10.00 | 10.00 |
| Thiodiglycol | | | | | | | |
| Triethylene glycol | | | | | | | |
| monobutyl ether | | | | | | | |
| 1,5-Pentanediol | | | | | | | |
| Dipropylene glycol-n-propyl | | | | | | | |
| ether | | | | | | | |
| Triethanolamine | | | | | | | |
| OLFINE E1010 | | | | | | | |
| Proxel GXL(S) | 0.05 | 0.05 | 0.05 | 0.05 | 0.05 | 0.05 | 0.05 |
| Ion-exchanged water | 41.95 | 41.95 | 42.45 | 41.95 | 41.95 | 41.95 | 42.45 |
| containing Acetylenol E100 | | | | | | | |
| Content Q (%) of first | 0.00 | 0.00 | 4.00 | 4.00 | 4.00 | 4.00 | 4.00 |
| pigment | | | | | | | |
| Content A (%) of second | 0.05 | 0.05 | 0.00 | 0.00 | 0.00 | 0.00 | 0.0004 |
| pigment | | | | | | | |
| Value (times) of A/Q | — | — | 0.000 | 0.000 | 0.000 | 0.000 | 0.0001 |
| Hue angle “h (°)” of diluted | 4 | 336 | 335 | 336 | 336 | 340 | 329 |
| solution | | | | | | | |
| Hue angle (°) of second | 101 | 101 | — | 105 | 109 | — | 101 |
| pigment | | | | | | | |
| γ₁₀ (mN/m) | 45.0 | 45.0 | 45.0 | 45.0 | 45.0 | 45.0 | 45.0 |

TABLE 4-6
Composition and characteristics of ink

| | Ink | | | | | | |
|---|---|---|---|---|---|---|---|
| | 36 | 37 | 38 | 39 | 40 | 41 | 42 |
| Pigment dispersion liquid 1 | 40.00 | | | | | | 80.00 |
| Pigment dispersion liquid 2 | | 40.00 | | | | | |
| Pigment dispersion liquid 3 | | | | | | | |
| Pigment dispersion liquid 4 | | | | | | | |
| Pigment dispersion liquid 5 | | | | 40.00 | | | |
| Pigment dispersion liquid 6 | | | | | | | |
| Pigment dispersion liquid 7 | | | | | | | |
| Pigment dispersion liquid 8 | | | | | | | |
| Pigment dispersion liquid 9 | | | | | | | |
| Pigment dispersion liquid 10 | | | | | | | |
| Pigment dispersion liquid 11 | | | 42.50 | | | | |
| Pigment dispersion liquid 12 | | | | | 23.00 | | |
| Pigment dispersion liquid 13 | | | | | | | |
| Pigment dispersion liquid 14 | 10.00 | 1.82 | | 7.20 | | 1.00 | |
| Pigment dispersion liquid 15 | | | | | | | |
| Pigment dispersion liquid 16 | | | | | | | |
| Pigment dispersion liquid 17 | | | | | | | |
| Pigment dispersion liquid 18 | | | | | | | |
| Pigment dispersion liquid 19 | | | | | | | |
| Pigment dispersion liquid 20 | | | | | | | |
| Pigment dispersion liquid 21 | | | | | | | |
| Pigment dispersion liquid 22 | | | | | | | |
| Pigment dispersion liquid 23 | | | 2.50 | | | | |
| Pigment dispersion liquid 24 | | | | | 10.00 | | |
| Aqueous solution of resin 1 | 7.50 | 7.50 | | 7.50 | | 7.50 | 7.50 |
| Glycerin | 10.00 | 10.00 | 10.00 | 10.00 | 10.00 | 10.00 | 10.00 |
| Thiodiglycol | | | 2.00 | | | | |
| Triethylene glycol | | | 6.00 | | | | |
| monobutyl ether | | | | | | | |
| 1,5-Pentanediol | | | 1.00 | | | | |
| Dipropylene glycol-n-propyl | | | | | 2.50 | | |
| ether | | | | | | | |
| Triethanolamine | | | 0.90 | | | | |
| OLFINE E1010 | | | 1.00 | | | | |
| Proxel GXL(S) | 0.05 | 0.05 | 0.05 | 0.05 | 0.05 | 0.05 | 0.05 |
| Ion-exchanged water | 32.45 | 40.63 | 34.05 | 35.25 | 54.45 | 81.45 | 2.45 |
| containing Acetylenol E100 | | | | | | | |
| Content Q (%) of first | 4.00 | 4.00 | 8.50 | 4.00 | 3.45 | 0.00 | 8.00 |
| pigment | | | | | | | |
| Content A (%) of second | 1.00 | 0.18 | 0.00 | 0.72 | 1.50 | 0.10 | 0.00 |
| pigment | | | | | | | |
| Value (times) of A/Q | 0.250 | 0.045 | 0.000 | 0.180 | 0.435 | — | 0.000 |
| Hue angle “h (°)” of diluted | 40 | 346 | 350 | 15 | 45 | 101 | 335 |
| solution | | | | | | | |
| Hue angle (°) of second | 101 | 101 | 93 | 101 | 101 | 101 | — |
| pigment | | | | | | | |
| γ₁₀ (mN/m) | 45.0 | 45.0 | 30.0 | 45.0 | 45.0 | 45.0 | 45.0 |

### <Evaluation>

Each of the inks 1 to 40 was filled into an ink cartridge and the cartridge was mounted in an ink jet recording apparatus (product available under the product name “PIXUS PRO-10S” from Canon Inc.) that ejected an ink from a recording head through the action of thermal energy. In Examples, the recording duty of a solid image recorded under such a condition that eight ink droplets having a mass of 4.0 ng per droplet are applied to a unit region measuring 1/600 inch by 1/600 inch is defined as 100%. In the present invention, in the following evaluation criteria of each item, the levels “AA”, “A” and “B” were defined as acceptable levels, and the level “C” was defined as an unacceptable level. The evaluation results are shown in Table 5.

### (Hue Angle of Magenta Ink)

The hue angle of a magenta ink was evaluated based on the following criteria from the “Hue angle “h (°)” of diluted solution” shown in Tables 4-1 to 4-6.
A: The hue angle “h (°)” was 330° or more to 345° or less.
C: The hue angle “h (°)” was less than 330° or more than 345°.

### (Sticking Recoverability)

The following operations were performed through use of the above-mentioned ink jet recording apparatus and a recording medium (product available under the product name “Canon Photo Paper/Glossy Gold (GL-101)” from Canon Inc.). After a recovery process (cleaning operation) was performed from a printer driver, a nozzle check pattern of “PIXUS PRO-10S” was recorded. After that, while a carriage was in operation (at a time point at which a recording head was at a position except a home position), a power cable was pulled out to leave the recording head uncapped. Then, the ink jet recording apparatus was left in this state for 14 days in an environment at a temperature of 30° C. and a relative humidity of 10%. Next, the ink jet recording apparatus was left in an environment at a temperature of 25° C. for 6 hours, and then the nozzle check pattern of “PIXUS PRO-10S” was recorded while the recovery process was performed. A nozzle check pattern 1 recorded before the ink jet recording apparatus was left for 14 days and a nozzle check pattern 2 recorded after the ink jet recording apparatus was left for 14 days were visually checked, and sticking recoverability was evaluated based on the following evaluation criteria. The case in which the number of recovery processes required for the nozzle check pattern 2 to reach a state equivalent to that of the nozzle check pattern 1 (which was normally ejected) is smaller means that the sticking recoverability is more excellent.
AA: After one or two recovery processes, the nozzle check pattern 2 reached a state equivalent to that of the nozzle check pattern 1.
A: After three to five recovery processes, the nozzle check pattern 2 reached a state equivalent to that of the nozzle check pattern 1.
B: After six to ten recovery processes, the nozzle check pattern 2 reached a state equivalent to that of the nozzle check pattern 1.
C: Even after ten recovery processes, the nozzle check pattern 2 did not reach a state equivalent to that of the nozzle check pattern 1, and an unrecorded portion was recognized.

### (Bronzing Resistance)

A solid image having a recording duty of 20% was recorded on a recording medium (product available under the product name “Canon Photo Paper/Glossy Gold (GL-101)” from Canon Inc.) with the above-mentioned ink jet recording apparatus. After the recorded solid image was dried for 1 day in an environment at a temperature of 23° C. and a relative humidity of 55%, the value of b* of specularly reflected light was measured with a variable angle high-speed spectrophotometer (product available under the product name “Model GCMS-3B” from Murakami Color Research Laboratory Co., Ltd.). Measurement conditions were set to a light source D65, a viewing angle of 2°, an incident angle of 45°, a reflection angle of 45° and a tilt angle of 0°. Then, the bronzing resistance of the image was evaluated based on the following evaluation criteria.
A: The value of b* was 9 or less.
B: The value of b* was more than 9 to 10 or less.
C: The value of b* was more than 10.

### (Suppression of Hue Angle Deviation)

A solid image having a recording duty of 70% was recorded on each of the following two kinds of recording media (recording media 1 and 2) with the above-mentioned ink jet recording apparatus.
Recording medium 1: Recording medium including an ink-receiving layer, available under the product name “Canon Photo Paper/Glossy Gold (GL-101)” from Canon Inc.
Recording medium 2: Recording medium free of an ink-receiving layer, available under the product name “ECF Bleached Paper (CS-680)”

Each of the recorded solid images was dried for 1 day in an environment at a temperature of 23° C. and a relative humidity of 55%. After that, the L*, a* and b* of reflected light were measured with a fluorescence spectrodensitometer (product available under the product name “FD-7” from Konica Minolta, Inc.) under the conditions of an illumination condition of M1 (D50), an observation light source D50 and a field of view of 2°. Then, the hue angle h₁ of the image recorded on the recording medium 1 and the hue angle h₂ of the image recorded on the recording medium 2 were calculated. A hue angle deviation (Δh=|h₁−h₂|) was calculated, and the suppression of the hue angle deviation was evaluated based on the following evaluation criteria.
AA: The Δh was 0.5 or less.
A: The Δh was more than 0.5 to 10 or less.
B: The Δh was more than 10.

TABLE 5
Evaluation results

| | | | | | | Suppression of |
|---|---|---|---|---|---|---|
| | | | Hue angle of | Sticking | Bronzing | hue angle |
| | | Ink | magenta ink | recoverability | resistance | deviation |
| Example | 1 | 1 | A | AA | A | AA |
| | 2 | 2 | A | AA | A | AA |
| | 3 | 3 | A | AA | A | AA |
| | 4 | 4 | A | AA | A | AA |
| | 5 | 5 | A | AA | A | AA |
| | 6 | 6 | A | AA | A | AA |
| | 7 | 7 | A | AA | A | AA |
| | 8 | 8 | A | A | B | A |
| | 9 | 9 | A | AA | A | AA |
| | 10 | 10 | A | AA | A | AA |
| | 11 | 11 | A | A | B | A |
| | 12 | 12 | A | AA | A | A |
| | 13 | 13 | A | AA | A | AA |
| | 14 | 14 | A | AA | A | AA |
| | 15 | 15 | A | AA | B | AA |
| | 16 | 16 | A | A | B | A |
| | 17 | 17 | A | A | B | A |
| | 18 | 18 | A | A | B | A |
| | 19 | 19 | A | A | B | A |
| | 20 | 20 | A | A | B | A |
| | 21 | 21 | A | AA | A | AA |
| | 22 | 22 | A | AA | A | AA |
| | 23 | 23 | A | A | B | A |
| | 24 | 24 | A | A | B | A |
| | 25 | 25 | A | A | B | A |
| | 26 | 26 | A | A | B | A |
| | 27 | 27 | A | A | B | A |
| Comparative | 1 | 28 | C | B | C | B |
| Example | 2 | 29 | C | B | C | B |
| | 3 | 30 | A | B | C | B |
| | 4 | 31 | A | C | C | B |
| | 5 | 32 | A | B | C | B |
| | 6 | 33 | A | B | C | B |
| | 7 | 34 | A | B | C | B |
| | 8 | 35 | C | A | B | A |
| | 9 | 36 | C | A | B | A |
| | 10 | 37 | C | A | B | A |
| | 11 | 38 | C | C | C | B |
| | 12 | 39 | C | B | C | B |
| | 13 | 40 | C | C | C | B |
| | 14 | 41 + 42 | — | — | C | B |

Examples 16 to 19 had the same evaluation ranks for all the sticking resistance, bronzing resistance and hue angle deviation, but Examples 16 and 17 were relatively inferior to Examples 18 and 19. Similarly, Examples 24 to 27 had the same evaluation ranks for all of the sticking resistance, bronzing resistance and hue angle deviation, but Examples 24 and 25 were relatively inferior to Examples 26 and 27. The hue angle deviation of Comparative Examples 4 to 6 had the same evaluation rank, but Comparative Example 4 was relatively inferior to Comparative Examples 5 and 6.

### Comparative Example 14

As Comparative Example 14, a solid image was recorded by applying two kinds of inks in a superimposed manner to a recording medium so that the recording duty of the ink 41 was 10% and the recording duty of the ink 42 was 10% with the above-mentioned ink jet recording apparatus. A product available under the product name “Canon Photo Paper/Glossy Gold (GL-101)” from Canon Inc. was used as the recording medium. Then, the bronzing resistance was evaluated based on the above-mentioned evaluation criteria to be the unacceptable level “C”.

A solid image was recorded by applying two kinds of inks in a superimposed manner to the recording media 1 and 2 so that the recording duty of the ink 41 was 35% and the recording duty of the ink 42 was 35% with the above-mentioned ink jet recording apparatus. Then, the suppression of the hue angle deviation was evaluated based on the above-mentioned evaluation criteria to be the level “B”.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-215835, filed Dec. 21, 2023, and Japanese Patent Application No. 2024-208489, filed Nov. 29, 2024, which are hereby incorporated by reference herein in their entirety.

What is claimed is:

1. An aqueous ink for ink jet comprising a pigment,
wherein the pigment comprises a first pigment that is a quinacridone pigment and a second pigment that is a monoazo pigment free of a condensed ring in a molecule thereof, and
wherein a hue angle of a diluted solution obtained by diluting the aqueous ink with water so that an absorbance at a maximum absorption wavelength in a wavelength range of from 380 nm to 780 nm is 1 is 330° or more to 345° or less.

2. The aqueous ink according to claim 1, wherein a content (% by mass) of the second pigment is 0.005 times or more to 0.040 times or less in terms of mass ratio to a content (% by mass) of the first pigment.

3. The aqueous ink according to claim 1, wherein the aqueous ink has a dynamic surface tension γ₁₀ at a lifetime of 10 milliseconds of 35.0 mN/m or more to 50.0 mN/m or less.

4. The aqueous ink according to claim 1, wherein the first pigment comprises a solid solution of a quinacridone pigment.

5. The aqueous ink according to claim 1, wherein the first pigment comprises a solid solution of C.I. Pigment Red 122 and C.I. Pigment Violet 19.

6. The aqueous ink according to claim 1, wherein the second pigment has a hue angle of 85° or more to 115° or less.

7. The aqueous ink according to claim 1, wherein the second pigment is a pigment formed of a compound represented by the following general formula (1): 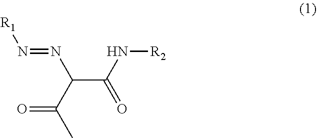
in the general formula (1), R₁ and R₂ each independently represent a substituted or unsubstituted benzene ring.

8. The aqueous ink according to claim 1, wherein the second pigment comprises C.I. Pigment Yellow 74.

9. The aqueous ink according to claim 1, wherein a content (% by mass) of the first pigment is 0.05% by mass or more to 14.50% by mass or less with respect to a total mass of the ink.

10. The aqueous ink according to claim 1, wherein a content (% by mass) of the second pigment is 0.01% by mass or more to 0.50% by mass or less with respect to a total mass of the ink.

11. An ink cartridge comprising:
an ink; and
an ink storage portion configured to store the ink,
wherein the ink comprises the aqueous ink according to claim 1.

12. An ink jet recording method comprising ejecting an ink from a recording head of an ink jet system to record an image on a recording medium,
wherein the ink comprises the aqueous ink according to claim 1.
